(19) United States
(12) Patent Application Publication
(10) Pub. No.: US 2018/0367667 A1
(43) Pub. Date: Dec. 20, 2018

(54) The system and method for location determination of devices

(71) Applicant: Minh-Duc Tran, Erie, PA (US)

(72) Inventor: Minh-Duc Tran, Erie, PA (US)

(73) Assignee: Safety Now Solutions LLC, Erie, PA (US)

(21) Appl. No.: 15/626,113

(22) Filed: Jun. 17, 2017

(51) Int. Cl. H04M 3/42; H04L 29/12

(52) U.S. Cl. CPC H04M 3/42348; H04L 61/157; H04L 61/609; H04M 2242/30; H04M 2242/04

(57) ABSTRACT

A method and system for determining location data of mobile and non-mobile devices in emergency situations and non-emergency situations. The method and system provides a set of user defined geospace location coordinates (X, Y, Z), a user defined physical geographic location address (e.g., building name, building address, building floor, a room on a building floor, campus, enterprise, city, state, region, country, continent, etc.), and additional text notes about the location.

### CROSS-REFERENCE TO RELATED APPLICATIONS

The application claims the benefit of the following patent applications

| | | |
|---|---|---|
| 2008/0101553 | May 2008 | Goldman |
| 2011/7937067 | May 2011 | Maier |
| 2011/0206036 | August 2011 | DeWeese |
| 2011/0244887 | October 2011 | Dupray |
| 2012/0309340 | December 2012 | Ray |
| 2013/0078943 | March 2013 | Biage |
| 2013/0178185 | July 2013 | Park |
| 2013/0237181 | September 2013 | Ray |
| 2014/8688070 | April 2014 | Scott |
| 2015/0156321 | June 2015 | Abnett |
| 2016/9402159 | July 2016 | White |

### Description

### Brief Summary of the Invention

The method and system uses a set of user defined geospace location coordinates (X, Y, Z), a user defined physical geographic location address, additional text notes, and a user assigned network device to correct the discrepancies of the global positioning system (GPS) and to correct the flaws of the reverse geocoding process. Reverse geocoding is the process of back (reverse) coding of a geospace location coordinates (X, Y, Z) to a readable physical location address or place. For rapid location determination, the method and system makes use of a local geolocation cache database stored on a first network device instead of relying on a geolocation cache database stored on a remote network server.

### BACKGROUND OF THE INVENTION

In the past, an emergency services provider (Public Service Answer Point—PSAP) could determine the current location of the caller by simply identifying the landline phone number associated with the incoming call. With the increase use of cellular phones, voice-over-IP, voice-over-LTE and other devices, the emergency services provider cannot reliably determine the location of the caller based on the caller's phone number alone. The emergency services provider may, for example, try to obtain location information for the caller using cell tower triangulation techniques or other, however, these techniques are often unreliable.

Current methods of locating a wireless or wired device make use of existing network servers, a wide area network, and wireless communication networks. Current methods include a first network device sending a set of pre-determined location coordinates (X, Y, Z) to a network server that stores the remote geolocation cache database. The network server, using the remote geolocation cache database, translates the pre-determined geospace location coordinates (X, Y, Z) into a physical geographic location address. The term dispatchable location can represent either the pre-determined geospace location coordinates (X, Y, Z) or the physical geographic location address. The network server then returns a dispatchable location to the first network device, which can relay the dispatchable location to the emergency services provider. It is important to note that the current method relies on a network server that makes use of a remote geolocation cache database.

In another example of current methods, the first network device receives inbound signals of pre-determined geospace location coordinates (X, Y, Z) from a plural of other network devices or wireless access points. The first network device then calculates the plurality of pre-determined geospace location coordinates (X, Y, Z) received in order to update the position of the first network device.

An additional example of current methods, the first network device stores a pre-determined radius of common areas of frequency (work, home, etc). When the first network device determines that its geospace location coordinates (X, Y, Z) are within the radius, then the first network devices makes use of the pre-determined location coordinates (X, Y, Z) assigned to the radius. This method is flawed and fails to work during scenarios where the first network device does not have enough time to acquire its current pre-determined geospace location coordinates (X, Y, Z) to compare data with the stored pre-determined radius. Such is the case when a user executes the emergency software on the first network device and immediately dials the emergency service number before there is time for the first network device to acquire the pre-determined geospace location coordinates (X, Y, Z).

The current methods mentioned above are unreliable for several reasons. The above mentioned methods do not explain the process of acquiring accurate pre-determined geospace location coordinates (X, Y, Z) on the first network device when the user is indoors or outdoors. Because the accuracy of the global positioning system (GPS) is affected by many factors, it is possible for the first network device to receive incorrect pre-determined geospace location coordinates (X, Y, Z) from the network servers or other network devices.

The global positioning system (GPS) is not consistent, even when triangulation techniques are employed. GPS accuracy varies due to GPS satellite geometry, signal blockage, atmospheric conditions, and the GPS receiver of the first network device. It known that GPS accuracy worsens near buildings, bridges, and trees because of signal reflection. GPS is more degraded when indoors or underground because signal blockage is severe in these scenarios. As a result, the first network device may send incorrect pre-determined geospace coordinates (X, Y, Z) to the network servers or the plurality of other network devices.

At times, the first network device's mapping software may be faulty due to incorrect drawn maps, mislabeled points of interest, missing roads, missing buildings, missing communities, and incorrect estimated street addresses may mislead users.

To add to the problem, a network server or network device may have faulty mapping software, which would result in faulty translations of the correct pre-determined geospace location coordinates (X, Y, Z) into an incorrect physical geographic location address. The network server and network device's mapping software may be faulty due to incorrect drawn maps, mislabeled points of interest, missing roads, missing buildings, missing communities, and incorrect estimated street addresses may mislead users.

There is an urgent need to improve the systems and methods of determining the indoors and outdoors geospace location coordinates (X, Y, Z) and physical geographic location address of cellular phones, smartphones, network devices, wireless devices, wireless access points, fixed access points, wired devices, wearable devices, other portable communications devices (e.g., voice communications devices), and computing devices, while still being able to provide the emergency services provider with an accurate dispatchable location when an emergency call is placed.

Having an accurate dispatchable location could benefit non-emergency services as well. Non-emergency services could rely on a dispatchable location where GPS is compromised. Some possible non-emergency services could include and not restricted to: drone deliveries, driverless vehicle location discovery, voice activated device location determination, wearable device location determination, services deliveries, and products deliveries.

### BRIEF DESCRIPTION OF DRAWINGS

Various embodiments of a network device location determination systems and methods are described below. In the course of this description, reference will be made to the accompanying drawings, which are not necessarily drawn to scale and wherein:

FIG. 1 is a block diagram of an example network operating environment for the first network device.

FIG. 2 is an example screenshot of a graphical user interface of the executable software on the first network device whereby the user shows intent to create a user defined location.

FIG. 3 is an example screenshot of a graphical user interface of the executable software on the first network device whereby the user refines the pre-determined geospace location coordinates (X, Y, Z.

FIG. 4 is an example screenshot of a graphical user interface of the executable software on the first network device whereby the user edits the physical geographic location address and assigns the chosen network device.

FIG. 5 is an example screenshot of a graphical user interface of the executable software on the first network device whereby the software shows detection of a matching network device to determine the dispatchable location.

FIG. 6 is an example screenshot of a graphical user interface of the executable software on the first network device whereby the user selects the chosen network device to associate with the dispatchable location.

FIG. 7 is a diagram of an example first network device displaying an image object representing the executable software.

### DETAILED DESCRIPTION OF THE INVENTION

Systems and methods according to various embodiments may be used to initiate and mediate an emergency call and to facilitate providing an accurate dispatchable location of a first network device to an emergency services provider that is handling the emergency call.

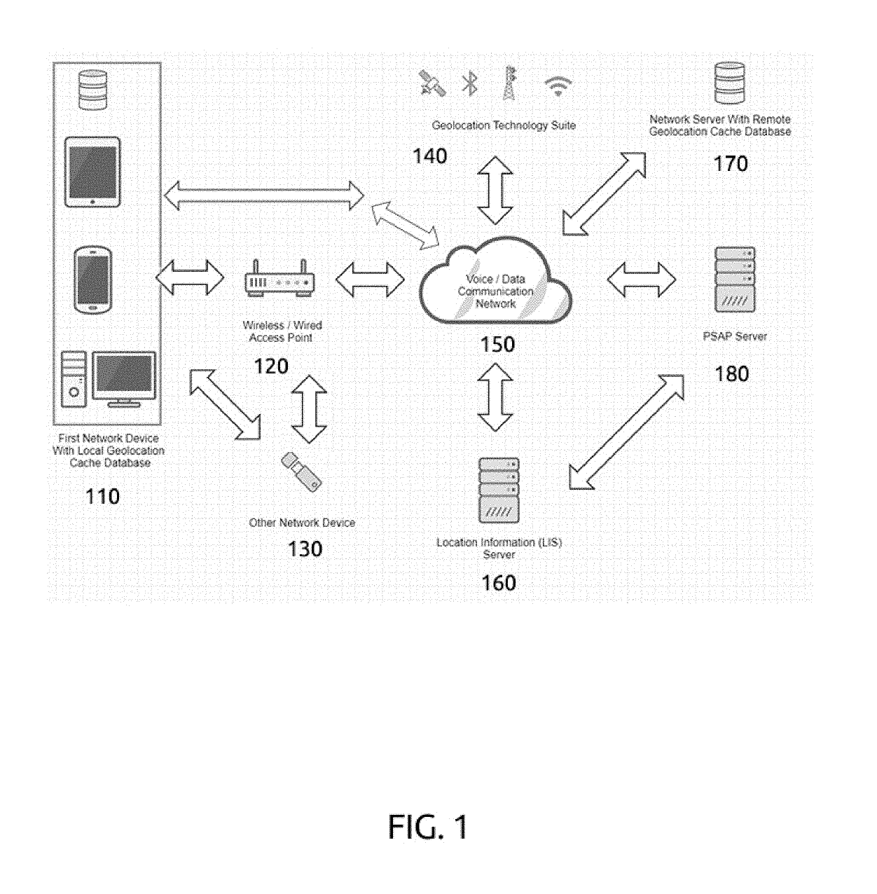

FIG. 1 is a block diagram of the system and method by which initial location is acquired and additional refinement of location by the user for the final dispatchable location. The first network device 110 can be for example, a handheld computer, a personal digital assistant, a cellular telephone, a smartphone, a network appliance, a camera, an enhanced general packet radio service (EGPRS) mobile phone, a navigation device, an email device, a game console, a VOIP telephone, a VOIP device, a tablet computer, a media player, a network base station, a wearable device, a voice activated device, or other electronic device or a combination of any two or more of these data processing devices or other data processing devices.

On initiation of the method to acquire the first network device's location, the outbound signal is sent to a wireless or wired access point network device 120 and then onto a plurality of voice/data communication network servers 150 which then passes the request onto a geolocation technology suite 140. The geolocation technology suite 140 returns inbound signals containing a pre-determined geospace location coordinates (X, Y, Z) back along the same path back to the first network device 110. In situations where the pre-determined geospace location coordinates (X, Y, Z) received are not accurate, the user will edit the position of the pre-determined geospace location coordinates (X, Y, Z) to create the user defined geospace location coordinates (X, Y, Z), which is stored onto a local geolocation cache database on the first network device 110. Once the user defined geospace location coordinates (X, Y, Z) are stored, the first network device 110 will send out an outbound signal requesting for a reverse geolocation service to translate the user defined geospace location coordinates (X, Y, Z) into a physical geolocation address. The outbound signal will be sent to the access point network device 120 to the plurality of voice/data communication network servers 150 which then passes the request to the network server with the remote geolocation cache database 170. The remote geolocation cache database 170 returns an inbound signal containing the translated physical geographic location address to the first network device 110 along the same network path. Upon receiving the translated physical geographic location address data, the user will determine to keep the translated physical geographic location address data received or if the user wishes to correct any inaccuracies in the physical geographic location address data. The end result of correcting the translated physical geographic location address will be referred to as a user defined physical geographic location address. Once the user defined physical geographic location address is saved onto the local geolocation cache database on the first network device 110, the first network device 110 will have both the user defined geospace location coordinates (X, Y, Z) and the user defined physical geographic location address. The term dispatchable location herein can represent either the user defined geospace location coordinates (X, Y, Z) or the user defined physical geographic location address.

To prepare the first network device 110 for rapid location determination that bypasses the use of the global positioning system (GPS), the user will associate the dispatchable location to a chosen available access point 120 or a chosen other network device 130. The access point 120 can be for example, a wireless or wired router. The access point 120 can emit an Internet Protocol (IP) address, Media Access Control (MAC) address, or Service Set Identifier (SSID), which can be used by the first network device 110 to associate the access point 120 with the dispatchable location.

The other network device 130 can be for example, a Bluetooth device, a WiFi device, a near field communication (NFC) device, a Wifi or Bluetooth button, a WiFi or Bluetooth wearable device, a WiFi or Bluetooth voice activated device, a fixed access or wired device, a device emitting a Radio Frequency Identification (RFID) signal, a NFC tag, a smartphone, a computer, or other data processing devices. The other network device 130 can emit an Internet Protocol (IP) address, a Media Access Control (MAC) address, a Service Set Identifier (SSID), or a device identification code, which can be recognized by the first network device 110 to associate the other network device 130 with the dispatchable location. Once the chosen access point 120 or other network device 130 is selected, the user will store the dispatchable location with the chosen access point 120 or other network device 130 onto the local geolocation cache database residing on the first network device 110.

When a first network device 110 detects an access point device 120 or other network device 130, it will look for a possible match of the mentioned devices on the local geolocation cache database residing on the first network device 110. If there is a match, then the first network device 110 will use the dispatchable location that is associated with the chosen access point 120 or chosen other network device 130 stored in the local geolocation cache database. This method bypasses the need to access the geolocation technology suite 140 and the remote geolocation cache database 170 to quickly acquire a dispatchable location, which in turn saves time during an emergency. This method prevents errors in location detection of the first network device 110 because errors can occur during the geolocation technology suite 140 acquisition of the geospace location coordinates (X, Y, Z) and errors can occur during translation of the geospace location coordinates (X, Y, Z) by the remote geolocation cache database 170.

When the local geolocation cache database on the first network device 110 does not locate a matching chosen access point 120 or chosen other network device 130, then the first network device 110 will not use the locally stored dispatchable location, and will determine the first network device's dispatchable location based on traditional location detection methods from the geolocation technology suite 140 that can include (1) the global positioning system; (2) one or more cell towers; (3) one or more networks (wireless or wired networks) (4) triangulation techniques.

When the user initiates the executable software on the first network device 110, the software will attempt to acquire the dispatchable location using either the local geolocation cache database or the traditional location detection methods. As the user initiates the emergency call, the software will continue to attempt to acquire the dispatchable location, and once a dispatchable location is available, the first network device 110, will send the outbound signal containing the dispatchable location along a network path including the (1) access point network device 120 (2) plurality of voice/data communication network 150 (3) Location Information Server 160 (4) Public Safety Answering Point server 180.

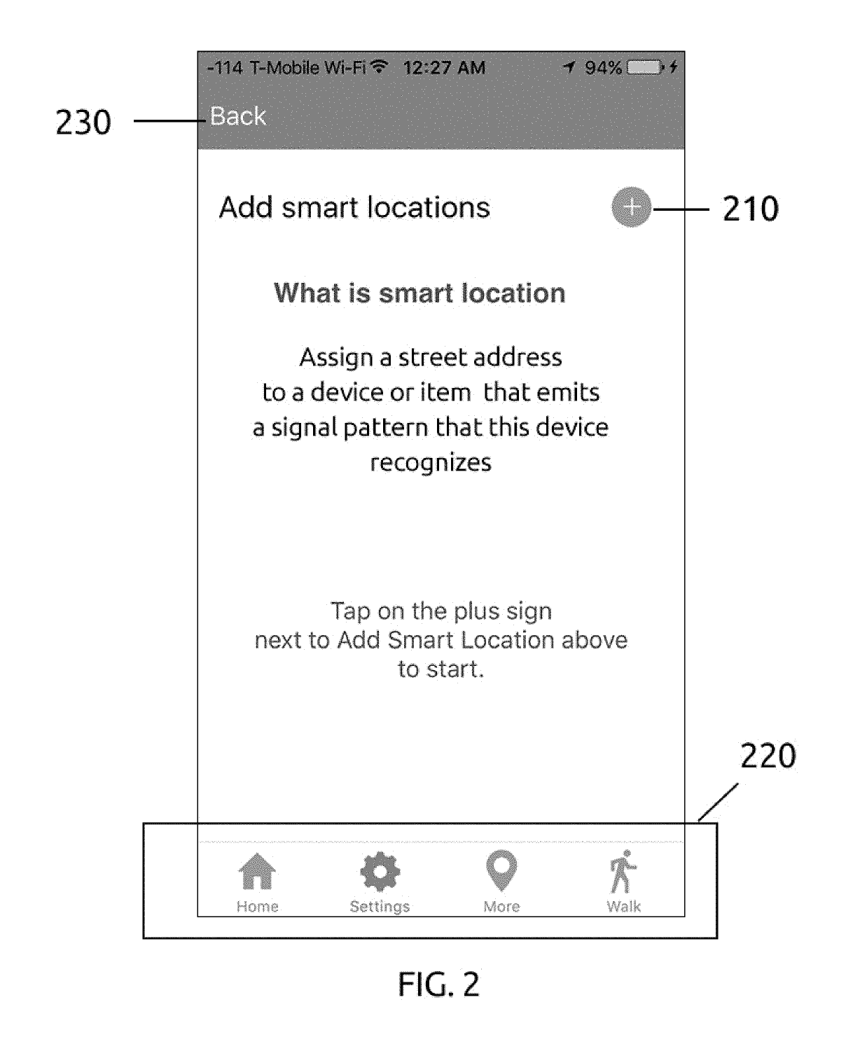

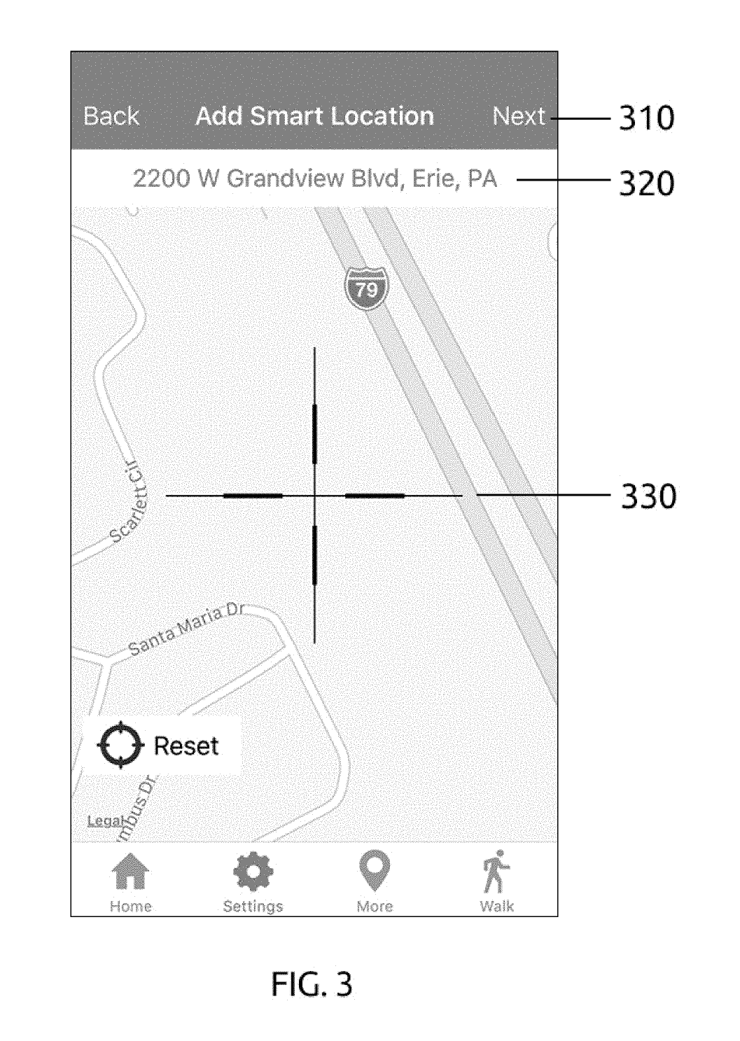

FIG. 2 is a screenshot of a graphical user interface of the executable software on the first network device 110 whereby the user can choose to begin the process of creating a user defined dispatchable location and associating the dispatchable location with the chosen access point 120 or other network device 130. In this implementation, the dispatchable location is referred to as a smart location. The example in FIG. 2 demonstrates the possibility of having multiple dispatchable locations on the first network device 110. By selecting the option Add smart locations 210, the user will be provided with the pre-determined geospace location coordinates (X, Y, Z) as seen in FIG. 3. The graphical user interface will have a navigation area 220 and 230 that will take the user to other screens where other features are offered. The navigation areas 220 and 230 will be a common theme of the graphical user interface of the executable software in this implementation. In some implementation on other first network devices, the graphical user interface may be different and the navigation areas 220 and 230 may be placed in other sections of the screen or may be represented in a different form. In some implementations, the process of adding the dispatchable location may start in a different order whereby the user starts with selecting the physical geographic location address or the user starts with selecting the chosen access point 120 or chosen other network device 130. Regardless of the sequence order, the end result will still be the same where the user will save the user defined geospace location coordinates (X, Y, Z), the user defined physical geographic location address, and the user associated chosen access point 120 or chosen other network device 130.

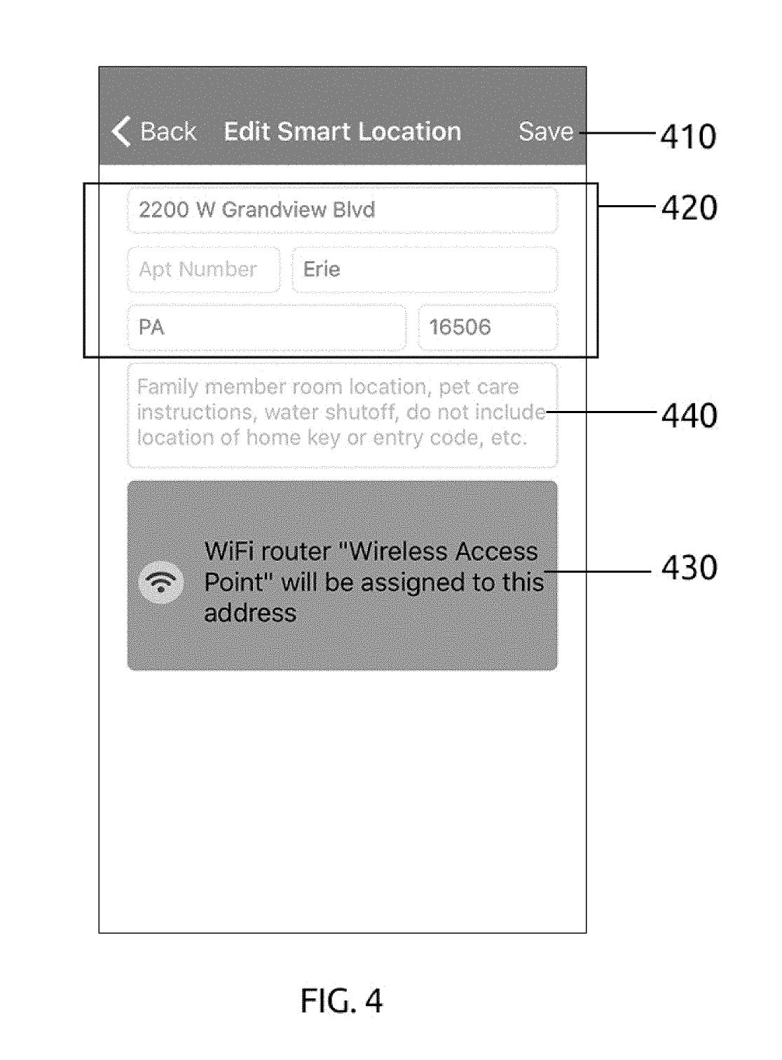

FIG. 3 is a screenshot of a graphical user interface of the executable software on the first network device 110 whereby the user receives the pre-determined geospace location coordinates (X, Y, Z) and the user edits the pre-determined location with a revised, user defined geospace location coordinates (X, Y, Z). When indoors, the first network device 110 may have difficulty with precise location detection due to signal interferences and obstructions of the global position system signal (GPS) or WiFi signal. The crosshair image 330 floating over the map allows the user to manipulate the initial pre-determined geospace location coordinates (X, Y, Z) and refine the location to a more accurate user defined geospace location coordinates (X, Y, Z) to represent the improved and intended position of the user. The map image can be moved by the user, but the crosshair image 330 will be static and float over the movable map. The middle intersection of the crosshair image 330 represents the intended user defined geospace location coordinates (X, Y, Z). The suggested translated reverse geocoded address 320 is intended to help the user get an idea of their estimated current position, but it does not represent the correct physical geographic location address. Selecting the option Next 310 directs the user to the following screen FIG. 4, whereby, the user will view the suggested translated physical geographic location address related to the user defined geospace location coordinates (X, Y, Z).

FIG. 4 is a screenshot of a graphical user interface of the executable software on the first network device 110 demonstrating the suggested translated physical geographic location address. In some cases, the remote geolocation cache database may not have any available physical geographic location address information related to the user defined geospace location coordinates (X, Y, Z) or the remote geolocation cache database may incorrectly translate the user defined geospace location coordinates (X, Y, Z) into an incorrect physical geographic location address. In the address entry fields 420, the user will have the opportunity to edit and correct the suggested translated physical geographic location address into a correct user defined physical geographic location address. The lower section of the graphical interface 430 shows the current available access point 120 or other network device 130 that will be associated with the dispatchable location 330, 420. The entry field 440 allows for additional text notes about the location whereby the user can enter the building name, floor level, entrance information, and other information that the user finds relevant. Selecting Save 410 on the user graphical user interface will save the dispatchable location 330, 420, additional notes 440, and the chosen access point 120 or other network device 430, 130 onto the local geolocation cache database that is stored on the first network device 110.

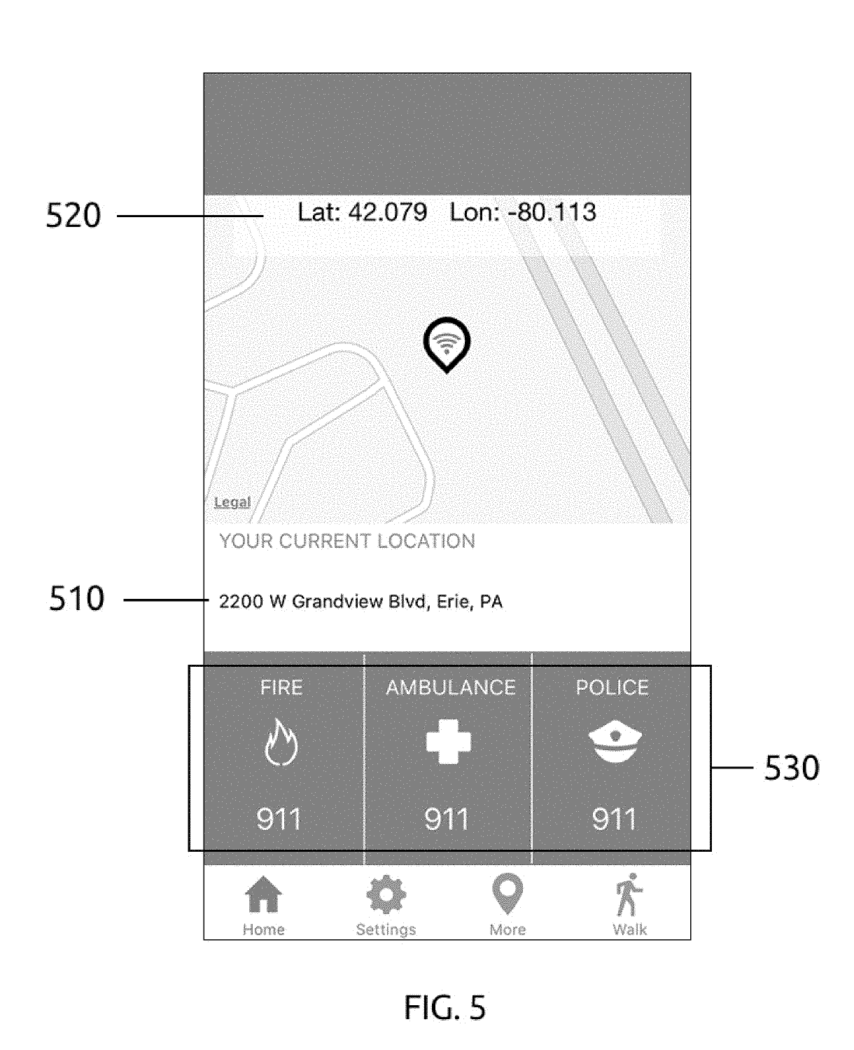

FIG. 5 is a screenshot of a graphical user interface of the executable software on the first network device 110 whereby the executable software detects an access point 120 or other network device 130 and seeks a matching access point or other network device stored on the local geolocation cache database on the first network device 110. When a match is determined, the executable software will use the associated dispatchable location 510, 520 and additional text notes 440 to be sent out to the Location Information Server 160 or PSAP server 180. This method allows for faster location determination of the dispatchable location compared to the amount of time it takes to acquire the global positioning system (GPS) position with the geolocation technology suite 140 or other traditional location detection methods. In an emergency, the user may only spend 2-3 seconds on the graphical interface screen before initiating an emergency call. In that short window of time, the first network device 110 may not be able to acquire the geospace location coordinates (X, Y, Z). In indoors scenarios, the first network device 110 may not be able to acquire the geospace location coordinates (X, Y, Z) at all, which demonstrates the advantage of the system and method of matching the access point 120 and other network device 130 to determine a dispatchable location. The navigation area 530 of the graphical interface, when selected, will initiate a 911 call and at the same time, send an outbound signal containing the dispatchable location 510, 520 along with the additional text notes 440 to the Location Information Server 160 or emergency services provider (PSAP server 180). When the local geolocation cache database on the first network device 110 does not locate a matching assigned network 120 or other network device 130, then the first network device 110 will not use the user defined geospace location coordinates (X, Y, Z) nor the user defined location address, and determine the first network device's dispatchable location based on traditional location detection methods from (1) the global positioning system; (2) one or more cell towers; (3) one or more networks (wireless or wired networks) (4) triangulation techniques. After traditional location detection methods determine a dispatchable location, the location data would be updated in sections 510, 520.

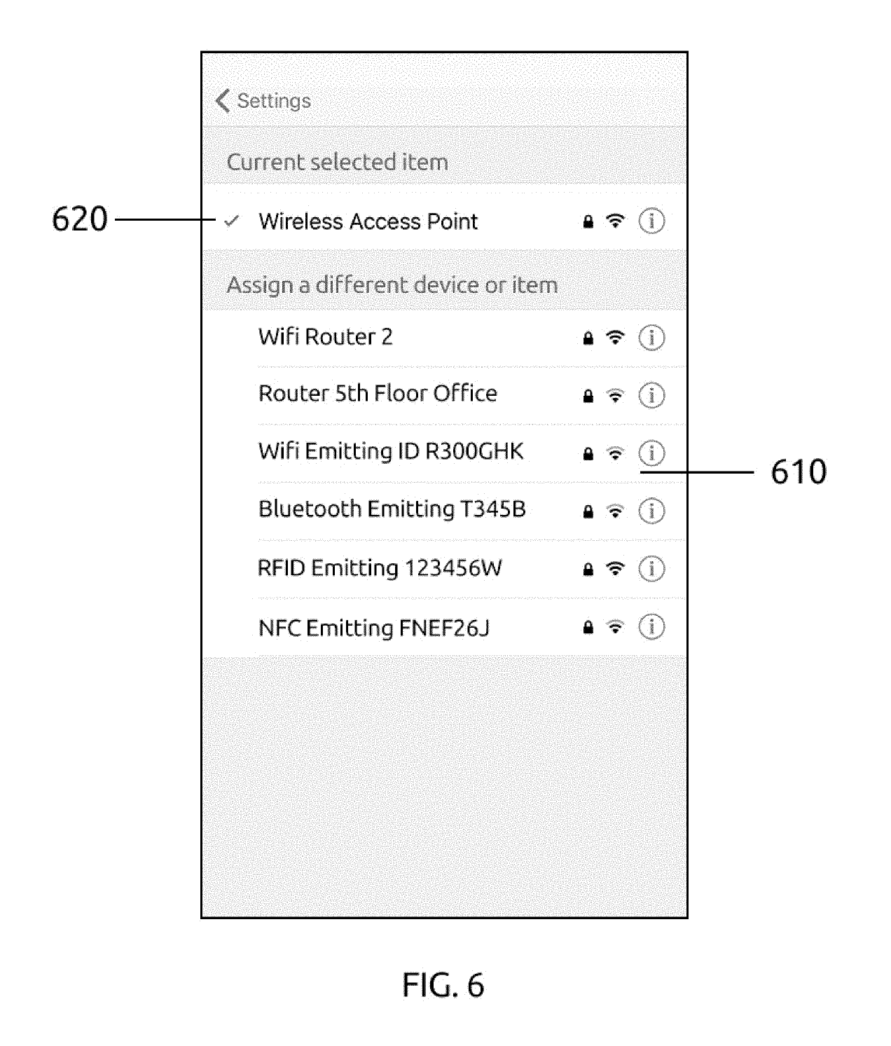

FIG. 6 is a screenshot of a graphical user interface of the executable software on the first network device 110 whereby the user can change the current chosen access point 120 or chosen other network device 130. In FIG. 4, when the area 430 is tapped, the user will be taken to the screen represented in FIG. 6. Area 620 of the graphical interface illustrates the current chosen access point 120 or chosen other network device 130. To assign the dispatchable location to a different network device, the user would tap on area 610 to select another available access point 120 or other network device 130 to associate with the dispatchable location.

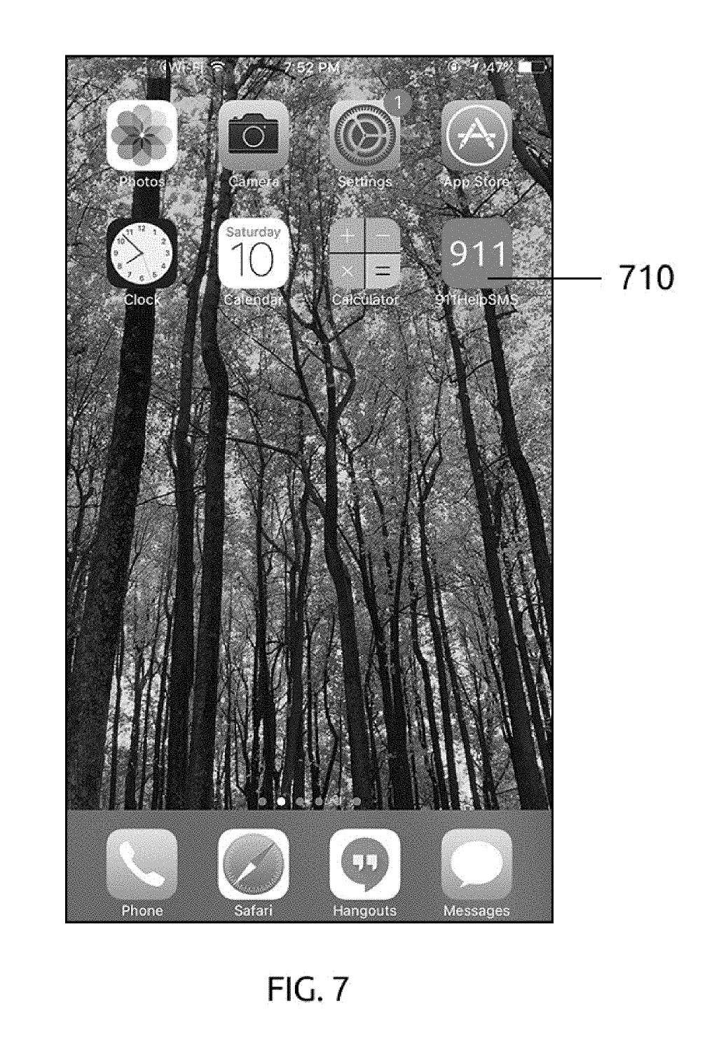

FIG. 7 is a screenshot of a graphical user interface on the first network device whereby the user will select the image object 710, representing the executable software, to initiate the software. When the user selects the image object 710, the executable software initiates the location detection systems and methods and displays the dispatchable location data in FIG. 5.

To provide for interaction with a user, the disclosed embodiments can be implemented on a computer, first network device, or other network device having a display device, e.g., a CRT (cathode ray tube), LCD (liquid crystal display) monitor, LED (light-emitting diode) monitor, or organic light-emitting diode (OLED) monitor, for displaying information to the user and a keyboard and a pointing device, e.g., a mouse or a trackball, by which the user can provide input to the computer, first network device, or other network device. Other kinds of devices can be used to provide for interaction with a user as well; for example, feedback provided to the user can be any form of sensory feedback, e.g., visual feedback, auditory feedback, motion feedback, or tactile feedback; and input from the user can be received in any form, including acoustic, speech, visual, motion, or tactile input.

In some implementations, it may be desired for the access point 120 or other network device 130 to store its own local geolocation database. In implementations whereby the access point 120 or other network device 130 do not have a display available, the first network device 110 can assign location data to the access point 120 or other network device 130. The executable software on the first network device 110 would acquire the user defined geospace location coordinates (X, Y, Z), the user defined physical geographic location address, and additional text notes. Then the executable software on the first network device 110 would store the user defined geospace location coordinates (X, Y, Z), the user defined physical geographic location address, and additional text notes onto the local geolocation database on each access point 120 or other network device 130. By storing its own local geolocation database, the access point 120 or other network device 130 can have device location determination independent of the first network device 110. The first network device can update the local geolocation database on the access point 120 or other network device 130 at any time.

The invention is not to be limited to the specific embodiments disclosed and that modifications and other embodiments are intended to be included within the scope of the appended claims. It should also be specifically understood that any steps executed within a set of computer-executable instructions would, at least in various embodiments, be executed by at least one computer processor associated with memory. Although specific terms are employed herein, they are used in a generic and descriptive sense only and not for the purposes of limitation

1. A method for locating a wireless or wired device to provide a dispatchable location, for an individual, to an emergency services provider or a non-emergency service, comprising:
executable software operatively installed on a first network device, the executable software displaying a user interface, on a display screen of the first network device, that is adapted to receive a request from a user to request initiation of an emergency call and to request the dispatchable location;
sending from the first network device, with one or more processors, a plurality of outbound signals to a voice or data communication network, each with one or more processors;
receiving on the first network device a plurality of inbound signals from the voice or data communication network, wherein location information in pre-determined geospace location coordinates (X, Y, Z) is updated in real-time on the first network device;
receiving on the first network device a plurality of inbound signals from the voice or data communication network, wherein the voice or data communication network, connecting to a geolocation technology suite, retrieves a set of pre-determined geospace location coordinates (X, Y, Z), and connecting to a remote geolocation cache database, translating the set of pre-determined geospace location coordinates (X, Y, Z) into a physical geographic location address, also known as the dispatchable location;
receiving on the first network device the set of pre-determined geospace location coordinates (X, Y, Z) from the plurality of inbound signals, wherein the set of pre-determined geospace location coordinates (X, Y, Z) are determined from a set of Extensible Markup Language (XML) objects or Javascript Object Notation (JSON) objects or a set of Uniform Resource Identifiers (URI) pre-assigned to a plurality of wireless network and network devices that are unique across any network an assigned URI is used on;
receiving on the first network device the physical geographic location address from the plurality of inbound signals, wherein the physical geographic location address is determined from the set of Extensible Markup Language (XML) objects or Javascript Object Notation (JSON) objects or the set of Uniform Resource Identifiers (URI) pre-assigned to the plurality of wireless network and network devices that are unique across any network an assigned URI is used on;
editing on the first network device the set of pre-determined geospace location coordinates (X, Y, Z) to create a user defined geospace location coordinates (X, Y, Z) to reflect the current position, and editing the physical geographic location address to create a user defined physical geographic location address along with additional text notes related to the location;
assigning the user defined geospace location coordinates (X, Y, Z), the user defined physical geographic location address, and additional text notes to a chosen network device, network label, or network type based on the network device's Media Access Control (MAC) address, Service Set Identifier (SSID), network device identification code, or other types of network (e.g., a network that uses Bluetooth (standard or low energy Bluetooth), beacon communication technologies (e.g., iBeacon), or near field communications to facilitate communication between computing devices);
storing the user defined geospace location coordinates (X, Y, Z), the user defined physical geographic location address, additional text notes, and the chosen network device, network label, or other types of network onto the local geolocation cache database stored on the first network device.
a local geolocation cache database storing user defined geolocation data and user associated network devices, wherein: in response to receiving the request from the user to initiate the emergency call, analyzing in real time, a geolocation position for the user by referencing the local geolocation cache database, to determine the dispatchable location for the user;

2. The method of claim 1, wherein: the step of storing, in computer memory, an associated MAC address, SSID, network device identification code, network label, or types of network with the assigned user defined geospace location coordinates (X, Y, Z), and the user defined physical geographic location address of a device when the location of the first network device satisfies a first set of one or more criteria.

3. The method of claim 1 wherein: the executable software determines current location information for the user; the step of analyzing current location data for the user starts with determining if the first network device recognizes any available chosen network device, SSID, MAC address, network device identification code, network label, or types of network that matches the network device, SSID, MAC address, network device identification code, network label, or types of network stored in the local geolocation cache database of the first network device, and if a match is found, then the first network device will use the matching user defined geospace coordinates (X, Y, Z) user defined physical geographic location address, and additional text notes provided by the local geolocation cache database.

4. The method of claim 1 wherein: when the local geolocation cache database on the first network device cannot locate a matching network device, then the first network device will not use the user defined geospace location coordinates (X, Y, Z) nor the user defined physical geographic location address, and determine the first network device's dispatchable location based on traditional location detection methods from (1) a global positioning system (GPS); (2) one or more cell towers; (3) one or more networks (wireless or wired networks) (4) triangulation techniques.

5. The method of claim 1 wherein the plurality of inbound signals and plural outbound signals include Session Initiation Protocol (SIP), Session Description Protocol (SDP), Internet Protocol (IP), Media Access Control (MAC), Commercial Mobile Radio Services (CMRS), cellular telephone, Personal Communications Services network (PCS), Packet Cellular Network (PCN), Global System for Mobile Communications, (GSM), Generic Packet Radio Services (GPRS), Cellular Digital Packet Data (CDPD), Wireless Application Protocol (WAP) or Digital Audio Broadcasting (DAB), Wireless Fidelity (Wi-Fi), Worldwide Interoperability for Microwave Access (WiMAX), IEEE 802.11xx, Global Positioning System (GPS) and GPS map, Digital GPS (DGPS), Instant Messaging (IM), Short Message Services (SMS), Radio Frequency Identifier (RFID) or Zigbee signals.

6. The method of claim 1 further comprising a wireless or wired access point.

7. The method of claim 1 wherein the plurality of geospace location coordinates (X, Y, Z) and the plurality of the physical geographic location addresses include a building address, building name, a room on a building floor, building floor in a building, building on a street, an enterprise, campus, village, town, city, state, country or continent or global region.

8. The method of claim 1 wherein the emergency event includes an E911 or NG911 communication.

9. The method of claim 1 further comprising a non-transitory computer readable medium having stored therein instructions for causing one or more processors to execute the steps of the method.

10. The non-transitory computer-readable medium of claim 1, wherein the first network device is a smartphone.

11. The non-transitory computer-readable medium of claim 1, wherein the first network device is a tablet computer.

12. The non-transitory computer-readable medium of claim 1, wherein the first network device is a voice activated computer or voice activated device.

13. The non-transitory computer-readable medium of claim 1, wherein the first network device is a wearable computer or wearable network device.

14. The non-transitory computer-readable medium of claim 1, wherein the first network device is a wireless access point.

15. The non-transitory computer-readable medium of claim 1, wherein the first network device is a wireless or wired network device.

16. The non-transitory computer-readable medium of claim 1, wherein the first network device is a fixed access point or wired access point.

17. The method of claim 1 wherein initiating an emergency call to the emergency services provider from the user, and providing to the emergency services provider, a dispatchable location for the user, the method comprising: using one or more computing devices to continuously monitor a location of the first network device; receiving, via the user's first network device, a request to place an emergency call; and in response to receiving the request to place an emergency call: (A) updating a particular data structure with a current dispatchable location for the user, as determined by the one or more computing devices that are continuously monitoring the location of the user's first network device, the particular data structure being a data structure that the emergency service provider will accesses to determine location information of the user contacting the emergency services provider; and (B) initiating an emergency call on the first network device to the emergency services provider.

18. The method of claim 1, wherein the step of using one or more computing devices to continuously monitor the location of the user's first network device comprises continuously using information from a plurality of different sources to determine the location of the first network device.

19. The method of claim 1, wherein sending from a wired or wireless first network device with one or more processors a plurality of outbound signals to a plurality of wired or wireless access point devices, with one or more processors, that are connected to a voice or data communication network, with one or more processors, that are connected to the PSAP server and Location Information Server, with one or more processors, wherein dispatchable location data including the user defined geospace location coordinates (X, Y, Z), the user defined physical geographic location address, and additional text notes are stored on the PSAP server and Location Information Server, and used by the emergency services provider and non-emergency services.
